(19) United States
(12) Patent Application Publication
(10) Pub. No.: US 2015/0101835 A1
(43) Pub. Date: Apr. 16, 2015

(54) Percussion Unit

(71) Applicant: Robert Bosch GmbH, Stuttgart (DE)

(72) Inventors: Rainer Nitsche, Kirchheim/Teck (DE); Antoine Vandamme, Gerlingen (DE); Thomas Winkler, Stuttgart (DE); Helge Sprenger, Stuttgart (DE); Haris Hamedovic, Moeglingen (DE); Wolfgang Fischer, Gerlingen (DE); Christian Bertsch, Markgroeningen (DE); Mario Eduardo Vega Zavala, Schwieberdingen (DE); Ulli Hoffmann, Niefern-Oeschelbronn (DE); Thilo Henke, Leinfelden-Echterdingen (DE); Achim Duesselberg, Kirchheim Unter Teck (DE)

(21) Appl. No.: 14/403,199

(22) PCT Filed: Apr. 24, 2013
(86) PCT No.: PCT/EP2013/058424

§ 371 Date: Nov. 24, 2014

(30) Foreign Application Priority Data
May 25, 2012 (DE) 10 2012 208 902.0

(51) Int. Cl. B25D 11/06

(52) U.S. Cl. CPC B25D 11/06
USPC 173/201

(57) ABSTRACT

Percussion unit, especially for a rotary hammer and/or percussion hammer, comprising a control unit which is designed for controlling a pneumatic percussion mechanism. According to the disclosure, the control unit comprises at least one load estimation device.

### PRIOR ART

There are already known percussion mechanism units, in particular for a rotary and/or percussion hammer, comprising a control unit that is provided to control a pneumatic percussion mechanism.

### DISCLOSURE OF THE INVENTION

The invention is based on a percussion mechanism unit, in particular for a rotary and/or percussion hammer, comprising a control unit that is provided to control a pneumatic percussion mechanism.

It is proposed that the control unit have at least one load estimator. A “percussion mechanism unit” in this context is to be understood to mean, in particular, a unit provided to operate a percussion mechanism. The percussion mechanism unit may have, in particular a control unit. The percussion mechanism unit may have a drive unit and/or a transmission unit, provided to drive the percussion mechanism unit. A “control unit” in this context is to be understood to mean, in particular, a device of the percussion mechanism unit that is provided to control, in particular, the drive unit and/or the percussion mechanism unit by open-loop and/or closed-loop control. The drive unit may be provided, in particular, to drive the percussion mechanism. Further, the drive unit may be provided to drive a tool with a rotary working motion. The drive unit may comprise, in particular, a motor, and a transmission unit for transmitting the drive motion. The control unit may preferably be realized as an electrical, in particular an electronic, control unit. A “rotary and/or percussion hammer” in this context is to be understood to mean, in particular, a power tool provided for performing work on a workpiece by means of a rotary or non-rotary tool, wherein the power tool may apply percussive impulses to the tool. Preferably, the power tool is realized as a hand power tool that is manually guided by a user. A “percussion mechanism” in this context is to be understood to mean, in particular, a device having at least one component provided to generate a percussive impulse, in particular an axial percussive impulse, and/or to transmit such a percussive impulse to the tool disposed in a tool holder. Such a component may be, in particular, a striker, a striking pin, a guide element, such as, in particular, a hammer tube and/or a piston, such as, in particular, a pot piston and/or other component considered appropriate by persons skilled in the art. The striker may transmit the percussive impulse directly or, preferably, indirectly to the tool. Preferably, the striker may transmit the percussive impulse to a striking pin, which transmits the percussive impulse to the tool. “Provided” is to be understood to mean, in particular, specially designed and/or specially equipped. A “load estimator” in this context is to be understood to mean, in particular, a device and/or an algorithm provided to estimate a value and/or characteristic of at least one unknown parameter, at least one input value being taken into account. Preferably, the load estimator takes account of at least one known parameter. “Parameters” in this context are to be understood to mean, in particular, influencing quantities. Parameters may have fixed values, and in particular parameters may be functions of time and/or of a rotary position and/or of further variables. Load estimators are known to persons skilled in the art, from control engineering. The load estimator may preferably be implemented, at least partially, as an algorithm on a computing unit. “Estimate” in this context is to be understood to mean, in particular, that an absolute value and/or value characteristic of the estimated parameter corresponds sufficiently well to an actual parameter for it to suffice as a representation of the actual parameter in the case of a given task. Persons skilled in the art will define a required precision of an estimate, depending on the task. Preferably, the estimate of a parameter may correspond sufficiently well to an actual value if it differs from the actual value by less than 50%, preferably by less than 25%. The control unit may evaluate the estimated parameter. It is possible to dispense with measurement of the actual parameter. The control unit can take account of parameters that can be measured only with a great deal of difficulty. The control unit can take account of parameters that can be measured only in an unreliable manner.

Further, it is proposed that the load estimator be realized as a load observer. A “load observer” in this context is to be understood to mean, in particular, a load estimator that estimates at least one parameter of a physical system, by means of a system model, from at least one input value. A “system model” in this context is to be understood to mean, in particular, a simplified mathematical simulation of a physical system. The system model includes, in particular, a dynamic model of the physical system. A dynamic model takes account, at least partially, of the effects of dynamic inertial forces of the physical system. In particular, the system model constitutes a simplified simulation of the physical system that is reliable for application if an absolute value and/or value characteristic of the estimated parameter corresponds sufficiently well to an actual parameter of the physical system for it to suffice as a representation of the actual parameter in the case of a given task. A “physical system” in this context is to be understood to mean, in particular, one or more components of the percussion mechanism unit, in particular a drive unit. The control unit may evaluate the estimated parameter. The parameter may be estimated in a particularly precise manner by means of a load observer. The load observer may take account of the influence of dynamic forces, at least partially.

Further, it is proposed that the control unit be provided to identify an operating state of the percussion mechanism. Preferably, the control unit is provided to identify and/or distinguish a percussion operating mode and/or idling operating mode of the percussion mechanism. However, the control unit may also be provided to identify other operating states of the percussion mechanism, in particular a percussion frequency, a percussion intensity, or other operating states considered appropriate by persons skilled in the art. A “percussion operating mode” in this context is to be understood to mean, in particular, an operating state of the percussion mechanism in which preferably regular percussive impulses are exerted by the percussion mechanism. An “idling operating mode” in this context is to be understood to mean, in particular, an operating state of the percussion mechanism that is characterized by absence of regular percussive impulses. In particular, in determining the operating state of the percussion mechanism, the control unit may take account of the parameter estimated by the load estimator. Advantageously, the operating state of the percussion mechanism may be identified. The control unit may set operating parameters of the percussion mechanism such that a desired operating state is ensured.

It is proposed that the control unit be provided to process at least one operating parameter. The operating parameter may constitute, in particular, an input value of the load estimator. Preferably, the operating parameter is constituted by an operating parameter of a drive closed-loop control. A “drive closed-loop control” in this context is to be understood to mean, in particular, a closed-loop control unit provided for closed-loop control of a rotational speed of the drive unit of the percussion mechanism unit. An “operating parameter of a drive closed-loop control” in this context is to be understood to mean, in particular, an operating parameter used by the drive closed-loop control for closed-loop control of the drive unit. Preferably, the operating parameter may be an electric power consumption of the drive unit and/or, particularly preferably, a rotational speed of the motor of the drive unit. If a rotational speed at a transmission is captured, the rotational speed of the motor may be calculated from this rotational speed in the case of a known transmission ratio. The control unit may use existing operating parameters. It is possible to dispense with measurement and/or determination of further operating parameters.

Further, it is proposed that the control unit be provided to process the operating parameter as a function of at least one known load and at least one load to be estimated. The load to be estimated may be, in particular, a small and/or rapid, highly dynamic load variation of the drive unit. A “load” in this context is to be understood to mean, in particular, a load moment that acts upon a drive shaft of the drive unit. In particular, the load to be estimated may be caused, at least partially, by the percussion operating mode, in particular by a cyclic movement of a piston of the percussion mechanism. A “small load variation” in this context is to be understood to mean, in particular, a load variation that, in the case of non-regulated operation of the drive unit, causes a rotational speed fluctuation of less than 10%, preferably of less than 5%. A “rapid and/or highly dynamic load variation” in this context is to be understood to mean, in particular, a load variation that occurs within a movement cycle of the piston, in particular during a revolution of an eccentric gear mechanism driving the piston. If known loads are taken into account, the load to be estimated can be determined with greater precision. In particular, the operating parameter can be used to estimate a small and/or highly dynamic load that, if the operating parameter is considered directly, is overlapped by known loads. “Overlapped” in this context is to be understood to mean, in particular, that the unknown parameter is a small proportion of the characteristic of the operating parameter, in particular less than 50%, preferably less than 30%, particularly preferably less than 10%, of an amplitude of the operating parameter. For example, through an operation of performing work with a rotary working motion, by means of a drilling tool, a load moment acting upon the drive unit may effect a greater alteration of a rotational speed or of an electric power consumption than the percussion operating mode of the percussion mechanism. Without known parameters being taken into account, identification of the percussion operating mode may not be possible from consideration of a change in the rotational speed and/or in the electric power consumption. Preferably, the control unit is provided to process a rotational speed of the drive unit as an operating parameter. The rotational speed can be captured in a particularly dynamic manner. There is no need for further sensors. Preferably, the control unit is provided to take account of known loads having a known period. The control unit may be provided to take account of time-periodic loads. Time-periodic loads may be dependent, in particular, on a frequency of an electric power supply to the drive unit. For example, a fluctuation of the electric power supply to the drive unit may correspond to twice the grid frequency of the electric power grid to which the percussion mechanism unit is connected. The control unit may be provided to take account of angle-periodic loads. Angle-periodic loads may be dependent, in particular, on a rotary position of the drive unit. An angle-periodic load may be dependent, in particular, on a transmission ratio of an eccentric gear mechanism that can vary with the rotary position of the drive unit. Preferably, the load estimator determines an estimate of the characteristic of the unknown load over time by subtracting the known quantities from a characteristic of the operating parameter over time, in particular from a measured rotational speed characteristic of the motor of the drive unit. The known loads in this case may be functions in dependence on time and/or on the rotary position of the drive unit. A known load may be a basic and/or setpoint rotational speed of the drive unit. This rotational speed changes only slowly, and may be determined by averaging over time and/or by means of a low-pass filter. Further known loads may be, for example, rotational speed fluctuations resulting from motor cyclic irregularity, from irregular voltage supply to the motor and from variable transmission ratios. These loads may be time-dependent and/or angle-dependent, according to their dependence. Functions of these loads may be determined by persons skilled in the art. The unknown load can be estimated in a particularly precise manner. The estimated load may be particularly suitable for identifying an operating state. The unknown load may preferably be a rotational speed fluctuation caused by the percussion operating mode. Alternatively, the functions of the load may be derived according to time. The basic rotational speed and/or setpoint rotational speed need not be taken into account. The sum of the known loads may be directly proportional to a load moment, in particular to a load moment caused by the percussion operating mode. The percussion operating mode can be identified in a particularly reliable manner.

Further, it is proposed that the control unit comprise a filter unit, which is provided to estimate an unknown load from the operating parameter by filtering with a known frequency band. The filter unit may have, in particular, the function of a load estimator. In particular, the operating parameter may be processed by a bandpass filter. The unknown load may occur in a known frequency band. The bandpass filter may preferably suppress frequencies outside of this frequency band. Effects of known loads having a frequency spectrum that differs from the unknown load may be suppressed. The unknown load may be estimated from the operating parameter by filtering, through the bandpass filter. The control unit can identify the operating state of the percussion mechanism. There is no need for elaborate calculation of the unknown load.

Further, it is proposed that the control unit be provided to determine the operating state by comparing the estimated load with at least one limit value. In particular, a percussion operating mode and/or the idling operating mode can be identified if the estimated parameter and/or a derivation of the estimated load is above or below the limit value.

Further, it is proposed that the control unit have a learning mode for determining at least one known load. In particular, the control unit, when in the learning mode, may learn constant loads, time-dependent loads and/or angle-dependent loads. For the loads, the control unit may have predefined functions, which have scaling parameters. In the learning mode, the percussion mechanism unit may average a rotational speed signal, in a time domain and in an angle domain, over known time-dependent and angle-dependent periods of stored functions for the loads, and set the scaling parameters such that the sum of the known loads results in a least possible deviation from the rotational speed signal. Preferably, a learning phase may be effected in the idling operating mode, in which the operating state to be identified by the control unit is absent. The known loads can be determined, advantageously, by the control unit. Loads that change over the service life of the percussion mechanism unit can be re-learned. This avoids the need for loads to be determined by the user and/or by persons skilled in the art.

It is proposed that the control unit have a dynamic model that is provided to estimate a driving torque of the drive unit. In particular, the control unit may have a dynamic model that is provided to estimate a driving torque of the motor, taking account of the electric power consumption of the motor. Preferably, the dynamic model takes account of a moment of inertia of the motor and/or the rotational speed of the motor and/or a flux-dependent motor constant and/or a friction constant and/or a linked flux and/or a load moment and/or a viscous frictional component and/or a turbulent frictional component. The dynamic model may take account of further influences, in particular also time-periodic and angle-periodic influences. A “flux” in this context is to be understood to mean an electromagnetic flux in the motor. The electromagnetic flux is dependent, in particular, on the electric power consumption of the motor and on the flux-dependent motor constant. The flux-dependent motor constant may be defined by a characteristic curve. The characteristic curve may be calculated, for example, by means of a finite-element model. Methods of determining a dynamic model for calculating a driving torque of a motor, taking account of the electric power consumption and the rotational speed, are known to persons skilled in the art. Preferably, the dynamic model is provided to estimate the load moment of the motor and/or of the drive unit. Preferably, the load observer of the control unit is realized as a Luenberger observer. A “Luenberger observer” in this context is to be understood to mean, in particular, a load observer, known to persons skilled in the art, that compares a value, estimated using a model of the observer, with an actually measured value. The difference may constitute a correcting element of the simulated model. An unknown quantity may be estimated from the difference between the estimated value and the measured value. A “quantity” in this context is to be understood to mean, in particular, a physical quantity. In particular, the model may be provided to estimate the rotational speed of the motor, taking account of the electric power consumption. The Luenberger observer may compare the estimated rotational speed with the measured rotational speed. A correcting element for the load moment may be adapted such that the difference between the estimated rotational speed and the measured rotational speed is minimized. The load observer may use the correcting element for the load moment to estimate the load moment of the motor. Further parameters may be provided, which determine how rapidly the correcting element is varied. These parameters may be selected by persons skilled in the art, in particular in dependence on a frequency spectrum of a parameter to be estimated. The load moment may be suitable for identifying the operating state of the percussion mechanism. In particular, the load moment may be suitable for identifying the percussion operating mode. The control unit may process the load moment in order to identify the operating state. There is no need for sensors for measuring the load moment. The percussion mechanism can be particularly robust and/or inexpensive. The load moment can be estimated in a particularly precise manner by means of the dynamic model. Dynamic effects and/or frictional effects and/or dependence of the motor constant on the electromagnetic flux can be taken into account. Preferably, the dynamic model can be implemented on the computing unit of the control unit. As an alternative to the Luenberger observer, persons skilled in the art may also use another suitable method, for example a Kalman filter, known to persons skilled in the art, for determining a quantity to be estimated, from a difference between the parameter estimated by means of the dynamic model and a measured parameter.

Further, it is proposed to determine model parameters of the dynamic model from a comparison of measured and estimated parameters. In particular, model parameters of the dynamic model may be determined in the learning mode. The learning mode is preferably implemented when the percussion mechanism is in the idling operating mode. The parameter to be estimated, in particular the load moment caused by the percussion operating mode, may be at least largely absent in the idling operating mode. “At least largely” in this context is to be understood to mean, in particular, that the parameters to be estimated assume less than 30%, preferably less than 10% of their value in the operating state to be identified. A difference of the value estimated by means of the dynamic model, in relation to the measured value, in particular of the rotational speed estimated by means of the dynamic model in relation to the measured rotational speed, may be due, in particular, to incorrect model parameters. Persons skilled in the art know various methods of modifying the model parameters in a learning mode, such that the difference is minimized. The dynamic model may include correcting parameters, which cause the estimated rotational speed to converge toward the measured rotational speed. Advantageously, a situation can be achieved wherein model parameters are determined in an automated manner. Changes in the course of the service life of the percussion mechanism can be taken into account.

Further, it is proposed that the control unit be provided to determine the operating state by comparing at least one estimated parameter with at least one limit value. The operating state may be output as a digital signal. In particular, a percussion operating mode can be identified if an estimated parameter exceeds a limit value. The estimated parameter may be, in particular, an estimated load moment. Preferably, the estimated parameter is an estimated load moment caused by the percussion operating mode. Preferably, a plurality of operating states may be assigned to a plurality of limit values of the estimated load moment. Preferably, a slope and/or frequency of an amplitude of the load moment can be assigned to an operating state. In particular, the control unit can identify the percussion operating mode in the case of the frequency of the amplitude of the load moment occurring in a frequency band, that is dependent on rotational speed, in the range of an unexpected percussion frequency of the percussion mechanism. An “unexpected percussion frequency” in this context is to be understood to mean, in particular, a percussion frequency that ensues, in the case of the percussion operating mode of the percussion mechanism, as a result of the drive rotational speed, because of the given transmission ratios of the drive unit of the percussion mechanism. The control unit can determine the operating state in a particularly reliable manner. Disturbing influencing quantities can be eliminated particularly effectively.

Further, it is proposed that the control unit be provided to set at least one operating parameter temporarily to a start value, in at least one operating state, for the purpose of changing from the idling operating mode to the percussion operating mode. “Changing” from the idling operating mode to the percussion operating mode in this context is to be understood to mean starting of the percussion mechanism from the idling operating mode. The change to the percussion operating mode may be effected, in particular, when the percussion mechanism is switched over from the idling mode to the percussion mode. An “operating parameter” in this context is to be understood to mean, in particular, a parameter generated and/or influenced by the percussion mechanism unit for the purpose of operating the percussion mechanism, such as, for example, a drive rotational speed, an operating pressure and or a throttle position. A “start value” in this context is to be understood to mean, in particular, a stable operating parameter that is suitable for reliable starting of the percussion mechanism. “Reliable” in this context is to be understood to mean, in particular, that, when the percussion mechanism is switched over from the idling mode to the percussion mode, the percussion operating mode ensues in more than 90%, preferably more than 95%, particularly more than 99% of cases. “Temporarily” in this context is to be understood to mean, in particular, a limited time period. In particular, the time period may be shorter than 30 seconds, preferably shorter than 10 seconds, particularly preferably shorter than 5 seconds. Reliable starting of the percussion operating mode can be achieved. A percussion operating mode may be possible with operating parameters that are unsuitable for percussion mechanism starting. Operating parameters that are unsuitable for percussion mechanism starting may be reliable as working values. An idling operating mode may be possible with operating parameters that are unsuitable for percussion mechanism starting. Operating parameters that are unsuitable for percussion mechanism starting may be reliable as idling values. Reliability of the percussion mechanism can be increased. A performance capability of the percussion mechanism can be increased. It is proposed that the control unit be provided to set the operating parameter to an above-critical working value, in at least one operating state, in a percussion operating mode. The control unit may be provided, in particular, to set an above-critical working value when a user requests a working value that is above-critical under given conditions. An “above-critical” working value in this context is to be understood to mean, in particular, an operating parameter with which a successful transition from the idling operating mode to the percussion operating mode is not ensured. In particular, in the case of a percussion mechanism in the percussion mode, with an above-critical operating parameter the percussion operating mode may start in fewer than 50%, preferably in fewer than 80%, particularly preferably in fewer than 95% of cases. A relationship between the operating parameter and a percussion amplitude of the striker, or of another component of the percussion mechanism serving to generate percussion, may have, in particular, a hysteresis. An above-critical operating parameter may be characterized, in particular, in that it is above or below a limit value, above or below which a function of the percussion amplitude in dependence on the operating parameter is multi-valued. An above-critical operating value during an already successful percussion operating mode may preferably be distinguished by a stable continuation of the percussion operating mode. A reliable starting of the percussion mechanism may preferably be effected with a start value. Preferably, the start value lies in a range of the operating parameter in which the function of the amplitude in dependence on the operating parameter is unambiguous. With the above-critical operating parameter, a performance of the percussion mechanism can be increased. A performance capability of a power tool equipped with the percussion mechanism can be increased. With the above-critical operating parameter, the percussion mechanism can be operated in a reliable manner. Preferably, the percussion mechanism, in idling mode, may be operated in the idling operating mode with an idling value that corresponds to the above-critical start value. Preferably, for the purpose of starting the percussion mechanism, the operating parameter is set temporarily to the start value. The percussion mechanism may be operated with the above-critical operating parameter in the percussion operating mode and in the idling operating mode. The percussion mechanism may be operated with the operating parameter, selected by the user, in the idling operating mode and in the percussion operating mode. The selected operating parameters can be identified particularly easily by the operator, including in the idling operating mode.

It is proposed that the operating parameter be a throttle characteristic quantity of a venting unit. A “throttle characteristic quantity” in this context is to be understood to mean, in particular, a setting of the venting unit that alters a flow resistance of the venting unit, in particular a flow cross section. A “venting unit” in this context is to be understood to mean, in particular, a ventilation and/or venting unit of the percussion mechanism. The venting unit may be provided, in particular, to balance the pressure and/or volume of at least one space in the percussion mechanism. In particular, the venting unit may be provided for ventilating and/or venting a space, in front of and/or behind the striker in the percussion direction, in a guide tube that guides the striker. Preferably, the operating parameter may be a throttle position of the venting unit of the space disposed in front of the striker in the percussion direction. If a flow cross section is enlarged in the case of this venting unit, venting of the space in front of the striker can be improved. A counter-pressure, against the percussion direction of the striker, can be reduced. A percussion intensity can be increased. If a flow cross section is reduced in the case of this venting unit, venting of the space in front of the striker can be reduced. A counter-pressure, against the percussion direction of the striker, can be increased. A percussion intensity can be reduced. In particular, a return movement of the striker, against the percussion direction, can be assisted by the counter-pressure. Starting-up of the percussion mechanism can be assisted. The operating parameter can ensure reliable start-up of the percussion mechanism. The operating parameter with a reduced flow cross section may be a stable operating parameter. It may be suitable as a start value. The operating parameter with an enlarged flow cross section can be a critical operating parameter in the case of increased performance capability of the percussion mechanism. It can be suitable as a working value.

In an advantageous design of the invention, it is proposed that the operating parameter be a percussion frequency. A “percussion frequency” in this context is to be understood to mean, in particular, an averaged frequency with which the percussion mechanism generates percussion impulses when in the percussion operating mode. In particular, the percussion frequency may be dependent on a percussion-mechanism rotational speed. A “percussion-mechanism rotational speed” in this context is to be understood to mean, in particular, a rotational speed of an eccentric gear mechanism that moves a piston of the percussion mechanism. The piston may be provided, in particular, to generate a pressure cushion for applying pressure to the striker. The striker may be moved, in particular, at the percussion frequency by the pressure cushion generated by the piston. There is preferably a direct relationship between the percussion frequency and the percussion-mechanism rotational speed. In particular, the absolute value of the percussion frequency 1/s may be the absolute value of the percussion-mechanism rotational speed revs/s. This is the case if the striker executes one stroke per revolution of the eccentric gear mechanism. In the following, therefore, the terms “frequency” and “rotational speed” are used as equivalents. In the case of designs of a percussion mechanism that are different from this relationship, persons skilled in the art will adapt the following statements accordingly. The percussion-mechanism rotational speed can be set particularly easily by the control unit. A percussion-mechanism rotational speed may be especially suited to one case of performing work. The percussion mechanism may have an especially high performance capability in the case of a high percussion-mechanism rotational speed. In the case of a higher percussion-mechanism rotational speed, the drive unit of the percussion mechanism may be operated with a higher percussion-mechanism rotational speed. A ventilation unit driven by the drive unit may likewise be operated with a higher rotational speed. Cooling of the percussion mechanism and/or of the drive unit by the ventilation unit can be improved. A function of the percussion amplitude of the percussion mechanism may be dependent on the percussion-mechanism rotational speed. In the case of a rotational speed above a limit rotational speed, the function may have a hysteresis, and be multi-valued. Starting of the percussion operating mode, in the case of switchover from the idling mode to the percussion mode, and/or restarting of the percussion operating mode after an interruption of the percussion operating mode may be unreliable and/or impossible. A percussion-mechanism rotational speed below the limit rotational speed may be used as a start value and/or working value for a stable percussion operating mode. A percussion-mechanism rotational speed above the limit rotational speed may be used as a working value for a critical percussion operating mode. Above a maximum rotational speed, a percussion operating mode may be impossible and/or unreliable. “Unreliable” in this context is to be understood to mean, in particular, that the percussion operating mode fails repeatedly and/or randomly, in particular at least every 5 minutes, preferably at least every minute.

Further, a mode change sensor is proposed, which is provided to signal a change of an operating mode. In particular, a change from the idling mode to the percussion mode can be signalled to the control unit by the mode change sensor. The mode change sensor may be provided to detect a contact pressure of a tool upon a workpiece. Advantageously, it can be identified when the user commences a working operation. Particularly advantageously, the mode change sensor can detect a switchover of the percussion mechanism, in particular opening and/or closing of idling openings, and of further openings, of the percussion mechanism that are provided for a change of operating mode. The mode change sensor can detect a displacement of an idling and/or control sleeve provided for changing the operating mode of the percussion mechanism. Advantageously, the control unit can identify when a change of the operating mode of the percussion mechanism occurs. Advantageously, the control unit can alter the operating parameter, in order to assist and/or enable the change of operating mode. The percussion operating mode can be started in a reliable manner.

Further, a hand power tool is proposed, in particular a rotary and/or percussion hammer, comprising a percussion mechanism unit according to the invention. The hand power tool may have the advantages described.

Further, a control unit of a percussion mechanism unit is proposed, having the properties described. A percussion mechanism unit comprising the control unit may have the advantages described. The control unit may be such that it can be retrofitted in the case of an existing control unit.

Further, a method is proposed, comprising a percussion mechanism unit having the properties described. The method may be particularly suitable for determining operating parameters.

A preferred control unit comprises a memory unit, which can retrievably store a program, describing the aforementioned method, for execution of the latter, and/or parameters and/or values for executing the aforementioned method, and comprises a computing unit for executing the aforementioned method, or aforementioned program.

### DRAWING

Further advantages are given by the following description of the drawing. The drawing shows four exemplary embodiments of the invention. The drawing, the description and the claims contain numerous features in combination. Persons skilled in the art will also expediently consider the features individually and combine them to create appropriate further combinations.

In the drawing:

FIG. 1 shows a schematic representation of a rotary and percussion hammer having a control unit according to the invention, in a first exemplary embodiment, in an idling mode,

FIG. 2 shows a schematic representation of the rotary and percussion hammer in a percussion mode,

FIG. 3 shows a representation of a sequence diagram of the control unit during operation of the percussion mechanism,

FIG. 4 shows a representation of a sequence diagram of the control unit in a learning mode,

FIG. 5 shows a representation of parameters that influence a rotational speed signal,

FIG. 6 shows a representation of parameters learned in the learning mode,

FIG. 7 shows a schematic representation of a possible definition of a start value, a limit value, a working value and a maximum value,

FIG. 8 shows a representation of a sequence diagram of the control unit of the percussion mechanism unit in the case of a change between an idling mode and a percussion mode,

FIG. 9 shows a representation of signal spectra of a rotary and percussion hammer in a second exemplary embodiment, in various operating states,

FIG. 10 shows a schematic representation of a rotary and percussion hammer in a third exemplary embodiment, in an idling mode,

FIG. 11 shows a representation of a block diagram of a load observer,

FIG. 12 shows a representation of a system comprising the load observer and a drive unit,

FIG. 13 shows a representation of a motor characteristic curve,

FIG. 14 shows an exemplary representation of an estimated and a measured load moment,

FIG. 15 shows an exemplary representation of the characteristic of the measured and the estimated load moment, and of an operating state of a percussion mechanism,

FIG. 16 shows a schematic representation of a venting unit of a percussion mechanism of a rotary and percussion hammer comprising a percussion mechanism unit, in a fourth exemplary embodiment, and

FIG. 17 shows a further schematic representation of the venting unit.

### DESCRIPTION OF THE EXEMPLARY EMBODIMENTS

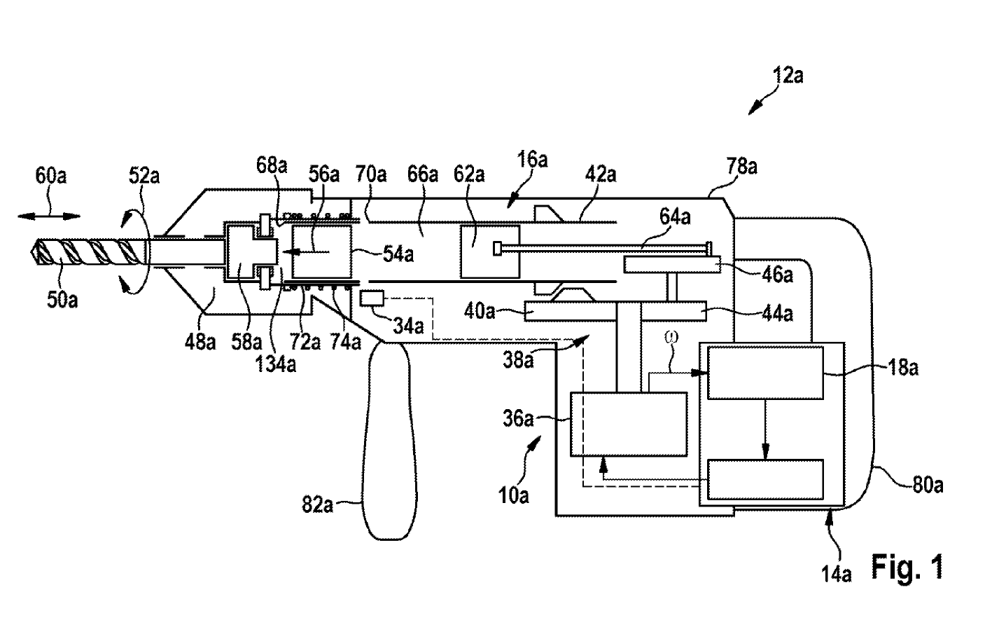

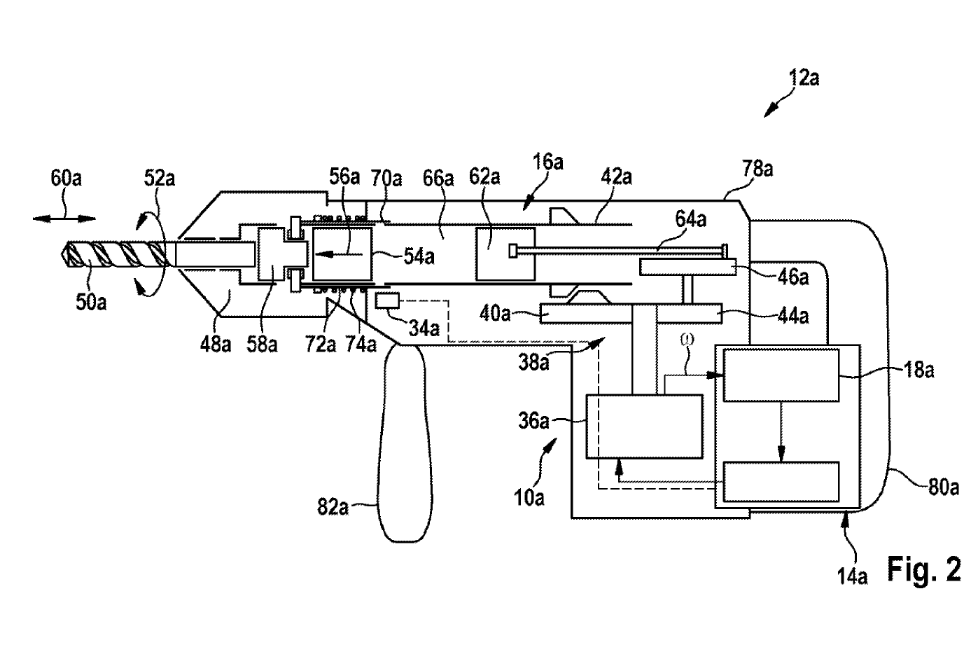

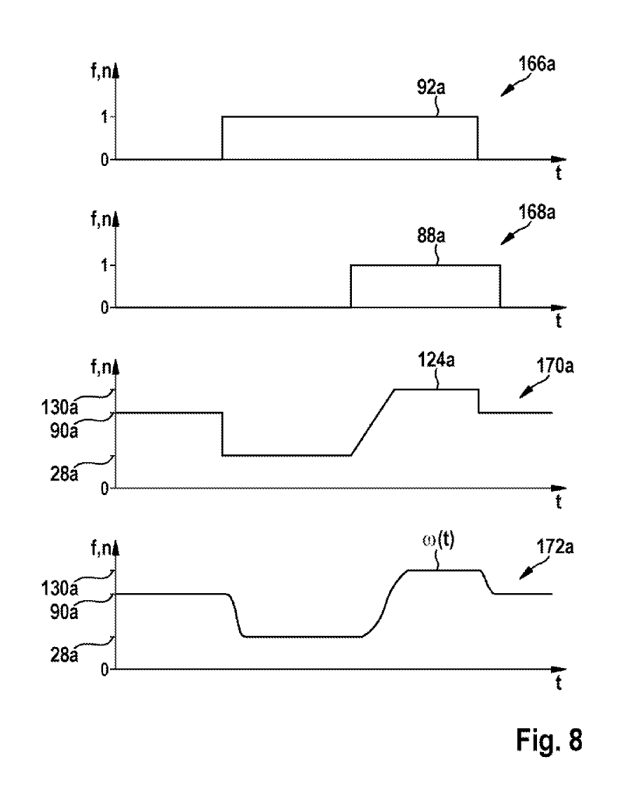

FIG. 1 and FIG. 2 show a rotary and percussion hammer 12a, having a percussion mechanism unit 10a, and having a control unit 14a, which is provided to control a pneumatic percussion mechanism 16a by open-loop and closed-loop control. The percussion mechanism unit 10a comprises a motor 36a, having a transmission unit 38a that drives a hammer tube 42a in rotation via a first gear wheel 40a and drives an eccentric gear mechanism 46a via a second gear wheel 44a. The hammer tube 42a is connected in a rotationally fixed manner to a tool holder 48a, in which a tool 50a can be clamped. For a drilling operating mode, the tool holder 48a and the tool 50a can be driven with a rotary working motion 52a, via the hammer tube 42a. If, in a percussion operating mode, a striker 54a is accelerated in a percussion direction 56a, in the direction of the tool holder 48a, upon impacting upon a striking pin 58a that is disposed between the striker 54a and the tool 50a it exerts a percussive impulse that is transmitted from the striking pin 58a to the tool 50a. As a result of the percussive impulse, the tool 50a exerts a percussive working motion 60a. A piston 62a is likewise movably mounted in the hammer tube 42a, on the side of the striker 54a that faces away from the percussion direction 56a. Via a connecting rod 64a, the piston 62a is moved periodically in the percussion direction 56a and back again in the hammer tube 42a, by the eccentric gear mechanism 46a driven with a percussion-mechanism rotational speed 124a (FIG. 8). The piston 62a compresses an air cushion 66a enclosed, between the piston 62a and the striker 54a, in the hammer tube 42a. Upon a movement of the piston 62a in the percussion direction 56a, the striker 54a is accelerated in the percussion direction 56a. The percussion operating mode can commence. The striker 54a can be moved back, contrary to the percussion direction 56a, by a rebound on the striking pin 58a and/or by a negative pressure that is produced between the piston 62a and the striker 54a as a result of the backward movement of the piston 62a, contrary to the percussion direction 56a, and/or by a counter-pressure in a percussion space 134a between the striker 54a and the striking pin 58a, and can then be accelerated for a subsequent percussion impulse back in the percussion direction 56a. Venting openings 68a are disposed in the hammer tube 42a, in a region between the striker 54a and the striking pin 58a, such that the air enclosed between the striker 54a and the striking pin 58a in the striking space 134a can escape. Idling openings 70a are disposed in the hammer tube 42a, in a region between the striker 54a and the piston 62a. The tool holder 48a is mounted so as to be displaceable in the percussion direction 56a, and is supported on a control sleeve 72a. A spring element 74a exerts a force upon the control sleeve 72a, in the percussion direction 56a. In a percussion mode (FIG. 2), in which the tool 50a is pressed against a workpiece by a user, the tool holder 48a displaces the control sleeve 72a against the force of the spring element 74a such that it covers the idling openings 70a. If the tool 50a is taken off the workpiece, the tool holder 48a and the control sleeve 72a are displaced by the spring element 74a in the percussion direction 56a such that openings 76a of the control sleeve 72a become positioned over the idling openings 70a, and release through-passages. A pressure in the air cushion 66a between the piston 62a and the striker 54a can escape through the idling openings 70a. In an idling operating mode (FIG. 1), the striker 54a is not accelerated, or is accelerated only slightly, by the air cushion 66a. In an idling operating mode, the striker 54a does not exert any percussion impulses, or exerts only slight percussion impulses, upon the striking pin 58a. The rotary and percussion hammer 12a has a hand power-tool housing 78a, having a handle 80a and an ancillary handle 82a, by which it is guided by the user.

The control unit 14a has a load estimator 18a. The load estimator 18a is integrated into the control unit 14a. The control unit 14a is provided to identify an operating state of the percussion mechanism 16a. The control unit 14a is provided to process at least one operating parameter. The control unit 14a is provided to process the operating parameter as a function of at least one known load and of at least one load to be estimated. The load estimator 18a of the control unit 14a is provided to estimate an unknown drive load f_{L}, using a measured motor rotational speed ω of the motor 36a. The unknown drive load f_{L} is an unknown load moment M_{L} acting upon the motor 36a.

A total moment M denotes the sum of all moments acting on the motor 36a. M comprises a drive moment of the motor M_{M} and the unknown load moment M_{L}. J is the rotational inertia of all parts of the motor 36a, transmission unit 38a and eccentric gear mechanism 46a that rotate with ω, wherein the transmission ratios must be taken into account. The following principle of angular momentum then applies:

$$J \frac{d ω ( t )}{d t} = \sum M$$

The total moment M is the sum of a moment M_{M} of the motor 36a and of moments M_{Li} of loads acting upon the motor 36a:

$$J \frac{d ω ( t )}{d t} = {M}_{M} + {M}_{L 1} + {M}_{L 2} + …$$

The motor rotational speed ω can be represented as a function of time ω(t), which is composed of a basic rotational speed ω₀ that does not change, or that changes only slowly, and of rapidly changing, highly dynamic components fᵢ(t), and of the sought drive load f_{L}:

ω(t)=ω₀+f₁(t)+f₂(t)+ . . . +f_{L}

The functions fᵢ(t) describe known loads. This equation is obtained by integration of the principle of angular momentum, and consequently the functions f do not have the dimension of a torque and are therefore denoted by the letter f instead of M. The procedure is known to persons skilled in the art. The load to be estimated f_{L} can be obtained by subtracting the known quantities from the measured motor rotational speed ω(t). In this case, f_{M}(t) is the function of the moment MM of the motor 36a:

f_{L}=ω(t)−ω₀−f_{M}(t)−f₁(t)−f₂(t)− . . .

The known load components fᵢ(t) describe, in particular, rotational speed fluctuations caused by variable transmission ratios, motor cyclic irregularities and an irregular voltage supply, e.g. by an activation of the motor. A distinction may be made between time-periodic loads fᵢ(t) and angle-periodic loads fᵢ(Φ). A time-periodic load fᵢ(t) may be, for example, a voltage fluctuation, in particular having double the grid frequency of an electric power supply to the rotary and percussion hammer 12a, and an angle-periodic load fᵢ(Φ) may be, for example, a transmission ratio that changes with a rotary position of the eccentric gear mechanism 46a. Loads whose characteristic is known precisely will be stored as a computational rule on the control unit 14a by persons skilled in the art.

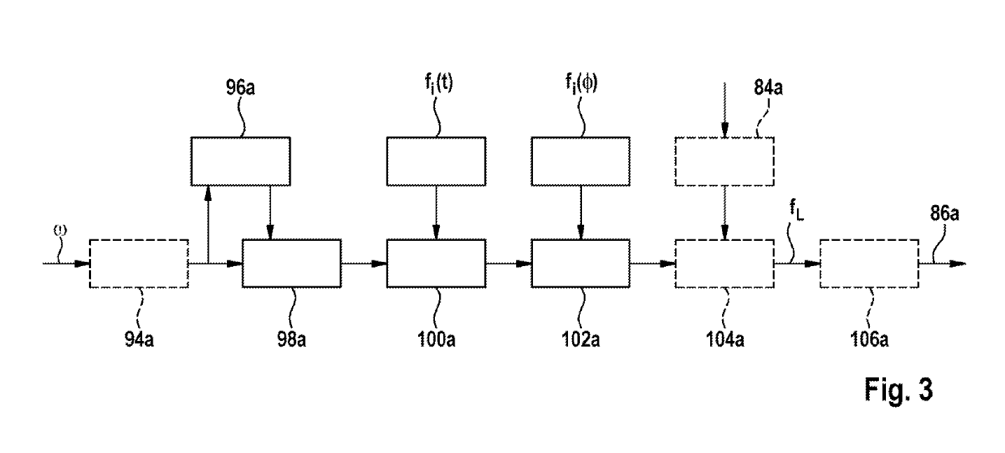

The control unit 14a is provided to identify the operating state of the percussion mechanism 16a. FIG. 3 shows a sequence diagram of the control unit 14a during operation of the percussion mechanism 16a. An input is the measured motor rotational speed ω. In a first step 94a, a sensor compensation may be effected, depending on a sensor used. In a further step 96a, a mean rotational speed is determined from the measured motor rotational speed ω. In a further step 98a, a difference of the measured motor rotational speed ω and the mean rotational speed is determined. Time-periodic loads fᵢ(t) are subtracted in a subsequent step 100a, and angle-periodic loads fᵢ(Φ) are subtracted in a subsequent step 102a. Optionally, influencing quantities 84a calculated from further input quantities may be subtracted in a step 104a. The result is the characteristic of the load to be estimated f_{L}, which may be further analyzed and/or filtered in a further step 106a. In particular, patterns may be processed, in particular a periodicity having an expected percussion frequency. The estimated load is output as a load quantity 86a. The operating state is determined by comparison of the load quantity 86a with a limit value. By means of this comparison, the control unit 14a can determine the operating state of the percussion mechanism 16a, in particular the percussion operating mode and the idling operating mode.

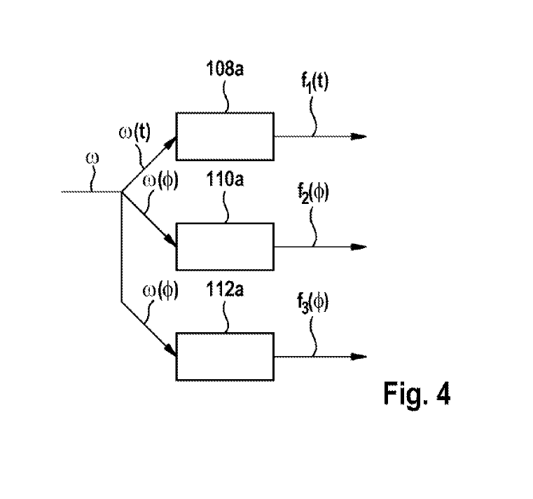

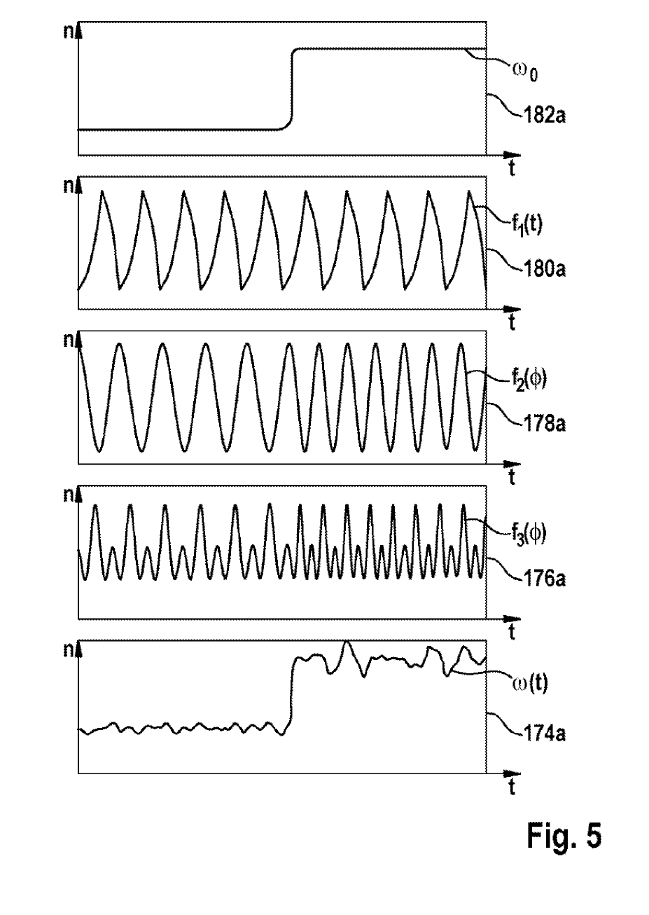

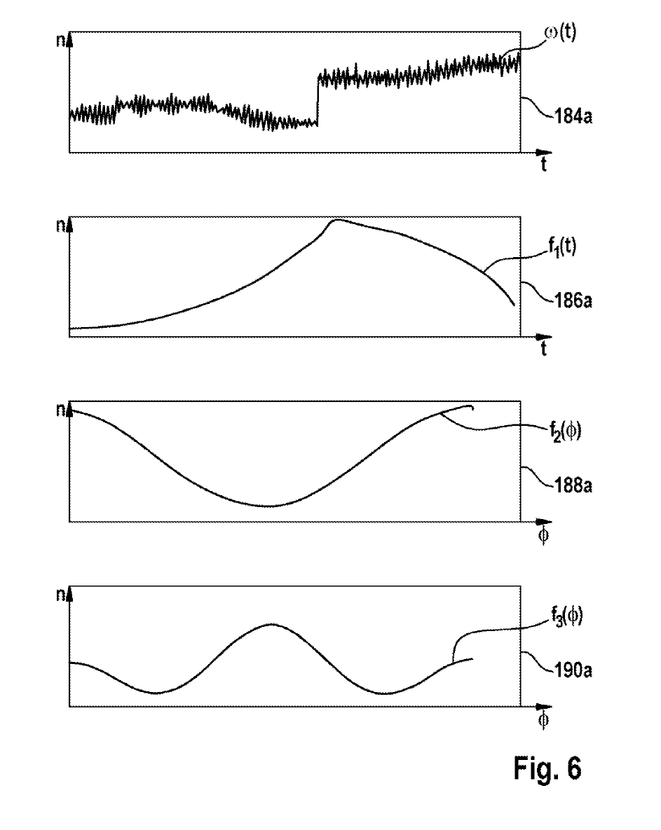

FIG. 4 shows a representation of a sequence diagram of the control unit in a learning mode, for the determination of known loads. The measured motor rotational speed ω is calculated as a function of time t (time domain) ω(t) based on time, and as a function of an angle Φ (angle domain) ω(Φ) based on angle. In an angle domain, it is possible to identify, in particular, periodic influences that are dependent on the rotary position of the eccentric gear mechanism 46a and/or of the motor 36a. In a step 108a, ω(t) is determined over a period t₁ from f₁(t). The result is the learned characteristic of the known load f₁(t). In a step 110a, ω(Φ) is determined over the periods Φ₂ from f₂(Φ) and, in a step 112a, over the period Φ₃ from f₃(Φ). The result is the learned characteristics of the known loads f₂(Φ) and f₃(Φ). The periods on an angle basis Φ are dependent on transmission ratios of the influences causing these loads to the motor rotational speed ω. Depending on the number of angle-periodic loads and time-periodic load components taken into account, these are determined from the measured motor rotational speed ω in the manner described. Persons skilled in the art will appropriately define the number of loads fᵢ to be learned. A greater number i increases the accuracy of determination of the load to be estimated f_{L}, and increases the effort required for calculating and defining and/or learning the loads. Advantageously, learning occurs in the idling mode, without influence of the load to be estimated f_{L}. The determination of the known loads fᵢ in the learning mode is explained further in the following FIGS. 5 and 6.

FIG. 5 shows a representation of parameters that influence the measured motor rotational speed ω. The parameters are the loads fᵢ (t), f₂(Φ) and f₃(Φ). The lowermost diagram 174a shows the characteristic of the measured motor rotational speed ω(t) in the time domain, which includes the influence of loads fᵢ. The diagrams 176a, 178a, 180a, from the bottom upward, show characteristics of two angle-periodic loads f₂(Φ) and f₃(Φ) with a differing period and a time-periodic load f₁(t). The topmost diagram 182a shows the characteristic of the basic rotational speed ω₀. The basic rotational speed ω₀ remains unchanged over a relatively long period, and may assume a new value upon a change of operating mode. The basic rotational speed ω₀ corresponds, for example, to a rotational speed setpoint value of the motor 36a for a desired percussion frequency.

FIG. 6 shows a representation of the characteristics of parameters learned in the learning mode. The learned parameters are the learned characteristics of the loads f₁(t), f₂ (Φ) and f₃(Φ). The topmost diagram 184a shows the measured motor rotational speed ω(t) in the time domain. Shown beneath are learned characteristics of the loads f₁(t), f₂(Φ) and f₃(Φ), in diagram 186a by averaging over the period t₁ from f₁(t), in diagram 188a by averaging over the period Φ₂ from f₂(Φ), and in diagram 190a by averaging over the period Φ₃ from f₃(Φ). In the present example, the period Φ₃ from f₃(Φ) is one revolution of the motor 36a, and the period Φ₂ from f₂ (Φ) is one revolution of the eccentric gear mechanism 46a.

The control unit 14a is provided to set at least one operating parameter temporarily to a start value 28a, in at least one operating state, for the purpose of changing from the idling operating mode to the percussion operating mode. The start value 28a may be, in particular, a percussion frequency at which a reliable percussion mechanism start is possible.

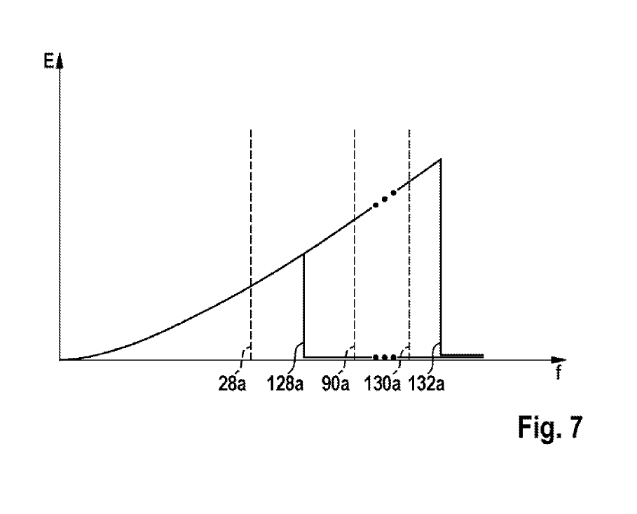

FIG. 7 shows a percussion energy E as a function of the frequency f and a possible definition of the start value 28a, a limit frequency 128a, a working frequency 130a and a maximum frequency 132a of the percussion frequency of the percussion mechanism 16a. In the case of a change of operating mode to the percussion mode, a reliable percussion mechanism start occurs below the limit frequency 128a. If, in the percussion operating mode, the percussion frequency, starting from a value below the limit frequency 128a, is increased into the range between the limit frequency 128a and the maximum frequency 132a, the percussion mechanism remains in the percussion operating mode as the percussion energy E increases. Above the limit frequency 128a, a change from the idling operating mode to the percussion operating mode does not occur, or occurs only in few cases; starting from the idling operating mode, the striker 54a cannot follow, or can scarcely follow, the movement of the piston 62a. Above the maximum frequency 132a, a percussion operating mode terminates in most cases. For the percussion operating mode, a working frequency 130a can be set after a percussion mechanism start has been effected, and the performance capability of the percussion mechanism 16a can thus be increased, as compared with operation below the limit frequency 128a. A percussion frequency or percussion mechanism rotational speed 124a above this maximum frequency 132a is not usable. The percussion mechanism rotational speed 124a in this case corresponds to the rotational speed of the eccentric gear mechanism 46a, and thus to the percussion frequency. Optionally, an idling value 90a may be defined for the idling operating mode, which idling value is advantageously higher than the start value 28a and lower than the working frequency 130a.

A mode change sensor 34a is provided to signal a change of the operating mode. The mode change sensor 34a transmits a signal 92a (FIG. 8) to the control unit 14a when the control sleeve 72a is displaced, such that the idling openings 70a are closed and the percussion mechanism 14a changes from the idling mode to the percussion mode. In particular, if a percussion frequency is selected that is higher than a start value 28a at which a reliable percussion mechanism start is possible, the control unit 14a first reduces the percussion frequency to the start value 28a. If the change from the idling operating mode to the percussion operating mode is identified by means of the load estimator 18a, the control unit 14a sets the percussion frequency to the selected percussion frequency.

FIG. 8 shows a sequence diagram of the operation of the percussion mechanism unit 10a. The diagram 166a shows the signal 92a of the mode change sensor 34a, wherein the value “1” signals the percussion mode. The percussion mechanism 16a is changed from the idling mode to the percussion mode if the mode change sensor 34a signals the change of the operating mode. The diagram 170a shows a setpoint value of the percussion-mechanism rotational speed 124a corresponding to the percussion frequency. The percussion-mechanism rotational speed 124a and the motor rotational speed ω(t) are used as equivalents here; for specific numerical values, it is necessary to take account of a transmission ratio between the motor 36a and the eccentric gear mechanism 46a. In the case of the percussion mode being identified, the setpoint value of the percussion-mechanism rotational speed 124a is lowered to the start value 28a. The diagram 168a shows a signal 88a of the load estimator 18a, wherein the value “1” signals the percussion operating mode. As soon as the percussion operating mode commences, the setpoint value of the percussion-mechanism rotational speed 124a is raised to the percussion-mechanism rotational speed 124a that corresponds to the working frequency 130a, wherein a delay parameter determines a slope of the rise. The percussion operating mode is then maintained until the mode change sensor 34a signals the change to the idling mode. The motor rotational speed ω(t) is represented in the lowermost diagram 172a.

The following description and the drawings of further exemplary embodiments are limited substantially to the differences between the exemplary embodiments and, in principle, reference may also be made to the drawings and/or the description of the other exemplary embodiments in respect of components having the same designation, in particular in respect of components having the same reference numerals. To differentiate the exemplary embodiments, the letters b, c and d have been appended to the references of the further exemplary embodiments, instead of the letter a of the first exemplary embodiment.

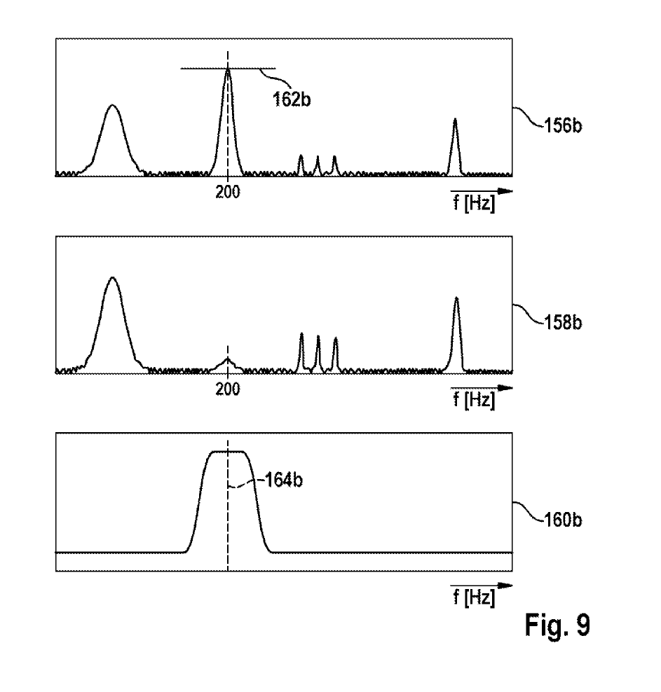

FIG. 9 shows a representation of signal spectra of a rotary and percussion hammer, not represented in greater detail here. The rotary and percussion hammer comprises a percussion mechanism unit, in a second exemplary embodiment that differs from the preceding exemplary embodiment in that a load estimator includes a filter unit, which is realized as a bandpass filter. The bandpass filter suppresses components of a rotational speed signal outside of a known frequency band excited by a percussion frequency. The percussion frequency corresponds to a rotational speed of an eccentric gear mechanism that drives a piston of a percussion mechanism. The percussion frequency excites oscillations having the percussion frequency itself, and/or oscillations having a multiple of the percussion frequency. A suitable frequency band that can be passed by the bandpass filter therefore lies in the range of the percussion frequency or a multiple of the percussion frequency. Depending on user settings, the percussion frequency lies in a range of 15 Hz-70 Hz. In FIG. 9, a percussion frequency of 40 Hz has been set. This frequency is not visible in the signal spectrum 156b during percussion operation. In the case of the rotary and percussion hammer of the second exemplary embodiment, a clear maximum 162b, having five times the percussion frequency, at 200 Hz, is clearly visible in the signal spectrum 156b. This is almost entirely absent in the signal spectrum 158b in the idling operating mode. In this exemplary embodiment, therefore, a mid-frequency 164b of a frequency response 160b of the bandpass filter is fixed to 5 times the percussion frequency. In the case of adjustment of the percussion frequency, or of the rotational speed of the eccentric gear mechanism, the mid-frequency 164b is altered accordingly. The clear maximum 162b in the case of five times the percussion frequency in the percussion operating mode is suitable for determining an operating state of the percussion mechanism, in particular an idling operating mode and the percussion operating mode. If a signal, present at an output of the bandpass filter, that has been filtered by the bandpass filter exceeds a defined threshold value, the percussion operating mode is identified. The threshold value, the mid-frequency 164b and a bandwidth of the bandpass filter will be appropriately defined in trials by persons skilled in the art. In the exemplary embodiment, the threshold value can be set by means of an operating element, not represented in greater detail.

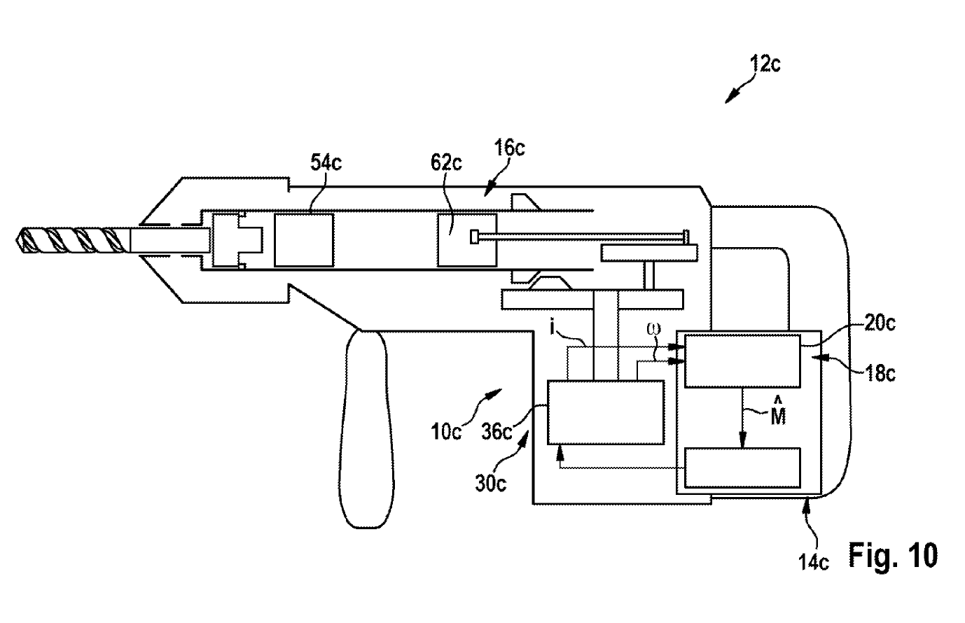

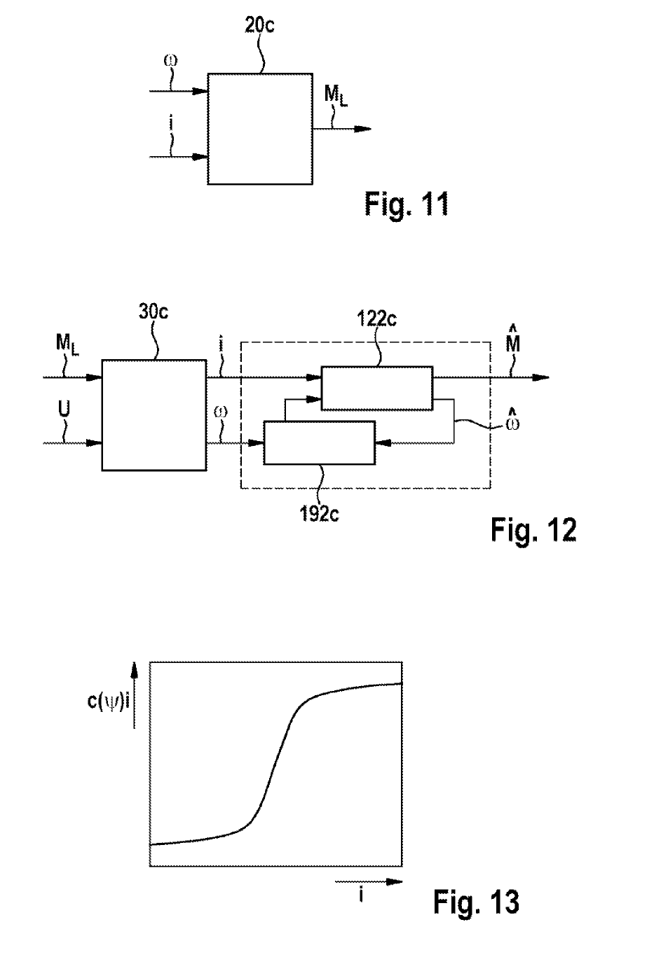

FIG. 10 shows a rotary and percussion hammer 12c having a percussion mechanism unit 10c, having a control unit 14c and a percussion mechanism 16c, in a third exemplary embodiment. The percussion mechanism unit 10c differs from the first exemplary embodiment in that a load estimator 18c is realized as a load observer 20c. The load observer 20c has a dynamic model, which is provided to estimate a load moment \hat{M}_{L} of a motor 36c of a drive unit 30c (FIG. 10). The load observer 20c determines the load moment M_{L} from a motor rotational speed ω and a motor current i of the motor 36c of the drive unit 30c (FIG. 11). FIG. 12 shows a system comprising the load observer 20c and the drive unit 30c operated with a voltage U. By means of a simulation element 122c of the dynamic model and the correcting element 192c, the load observer 20c uses the motor current i and the motor rotational speed ω to estimate the load moment \hat{M}_{L}. The basis of the load observer 20c is a model of the motor 36c, as a basis of the estimation algorithm:

$${J}_{M} \frac{d ω}{d t} = \underbrace{c ( Ψ ) i}_{{M}_{M}} - {M}_{L} - e - a ω - b {ω}^{2}$$

In this case, J_{M} is the moment of inertia of the motor 36c, ω is the motor rotational speed of the motor 36c, c is the flux-dependent motor constant, Ψ is the linked flux, M_{L} is the load moment acting on the motor 36c, e is a constant frictional component, aω is a viscous frictional component and bω² is a turbulent frictional component.

FIG. 13 shows a characteristic curve c(Ψ)i=c(i) of a flux-dependent motor constant for determination of the drive moment M_{M} as a function of the motor current i. The drive moment M_{M} is the moment that exerts a magnetic field, caused by the motor current i, upon the motor 36c. This characteristic curve may be determined by means of a finite-element model of the motor 36c, or by another method considered appropriate by persons skilled in the art. In the case of a direct-current motor, the motor constant is constant, and not dependent on Ψ, such that this relationship is simplified.

It is assumed that a load moment M_{L} changes only slowly with time, i.e. that the following applies approximately:

$$\frac{d {M}_{L}}{d t} = 0$$

The load observer 20c is realized as a Luenberger observer, known to persons skilled in the art, in which the motor rotational speed ω of the motor 36c estimated by the simulation element 122c of the dynamic model is compared with the actual rotational speed. In the following equation of a dynamics of the load observer, in which the constant frictional component and the turbulent frictional component have been disregarded, the estimated states are denoted by \hat{ω}, \hat{M}:

$${J}_{M} \frac{d \hat{ω}}{d t} = c ( Ψ ) i - {\hat{M}}_{L} - a \hat{ω} + {l}_{1} ( ω - \hat{ω} )$$

$$\frac{d {\hat{M}}_{L}}{d t} = {l}_{2} ( ω - \hat{ω} )$$

l₁ and l₂ represent correcting element 192c of the load observer 20c. Through appropriate selection of the coefficients l₁ and l₂, it is possible to influence the observer dynamics of the observer, i.e. the speed with which the estimated motor rotational speed \hat{ω} converges with the measured motor rotational speed ω in the case of a deviation. Persons skilled in the art will select a suitable observer dynamics to enable identification of an influence of the part of the load moment M_{L} that is caused by an operating state to be identified. It is advantageous to select an observer dynamics that corresponds at least to the duration of a movement cycle of a piston 62c and/or of a percussion cycle of a striker 54c of the percussion mechanism 16c. The load moment \hat{M}_{L} estimated by the load observer 20c corresponds in this case to a mean value of a load moment M_{L} present at the motor 36c during a percussion cycle. This mean value is influenced substantially by a piston movement, and differs significantly in a percussion operating mode and in an idling operating mode of the percussion mechanism 16c.

Techniques for determining the coefficients l₁ and l₂ for designing the observer dynamics are known to persons skilled in the art. If the load moment \hat{M}_{L} exceeds a threshold value, a percussion operating mode can be identified. Moreover, a characteristic of the load moment \hat{M}_{L} is recorded by the control unit 14c. A service state of the rotary and percussion hammer 12c can be deduced from a long-term trend of the load moment \hat{M}_{L}. A rise in the mean load moment \hat{M}_{L}, in particular in the idling operating mode, is an indication of increasing internal friction of the rotary and percussion hammer 12c. This is an indication of dirt accumulation, inadequate lubrication or further wear phenomena. A recommended service of the rotary and percussion hammer 12c is signalled to a user by a service light, not represented in greater detail here, as soon as a limit value of the mean load moment \hat{M}_{L} is exceeded and/or the mean load moment \hat{M}_{L} rises sharply in a time period. In the exemplary embodiment, a recommended service is signalled if, in the idling operating mode, the mean load moment \hat{M}_{L} is more than 50% higher than a reference value.

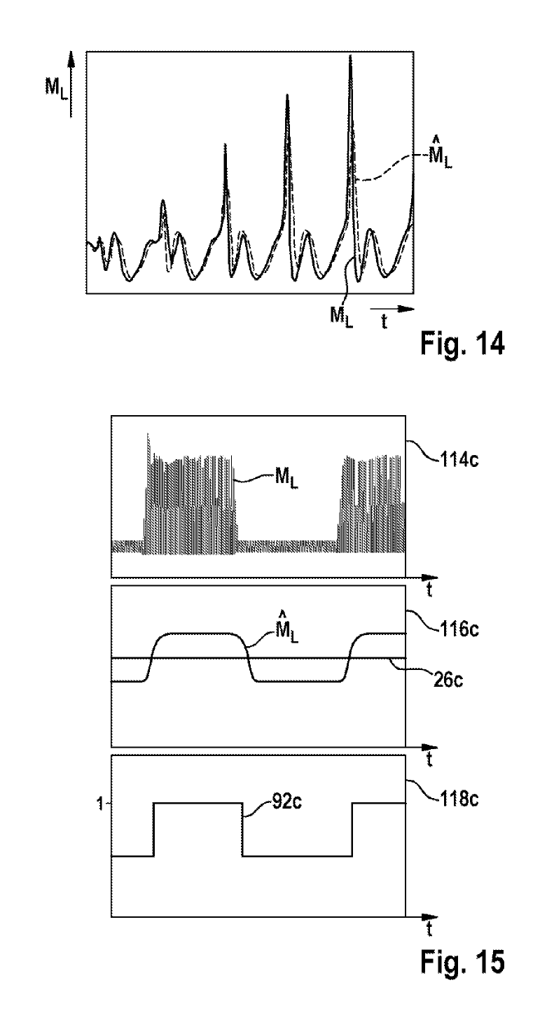

FIG. 14 shows, exemplarily, the characteristic of the actual load moment M_{L} and of a load moment \hat{M}_{L} estimated by the load observer 20c. The load observer 20c is implemented, advantageously, on the control unit 14c. The estimated load moment \hat{M}_{L} may be used on the control unit 14c as an input quantity of a control loop algorithm, for example for closed-loop control of the motor 36c. In the percussion operating mode, the load moment \hat{M}_{L} rises as a result of a periodically changing air pressure of an air spring between the striker 54c and the piston 62c, such that the air pressure can be estimated using the load moment \hat{M}_{L}. A control loop algorithm of the motor 36c can thus take account of the air pressure of the air spring. The period corresponds to the percussion frequency and to the rotational speed of an eccentric gear mechanism 46c. There is no need for measurement of the load moment M_{L}. Advantageously, the load observer 20c is implemented in a time-discrete form, for the purpose of calculation, on a digital signal processor of the control unit 14c. The transformation of the equations is effected by a Tustin approximation (bilinear approximation), known to persons skilled in the art.

The operating state is determined by a comparison of the estimated load with at least one limit value 26c. The upper diagram 114c of FIG. 15 shows a characteristic of the load moment M_{L}, the middle diagram 116c shows a characteristic of the load moment \hat{M}_{L} estimated by the load observer 20c, and the lower diagram 118c shows a signal 92c representing the operating state, wherein a value of “1” corresponds to the operating state “percussion operating mode”, and a value of “0” corresponds to the operating state “idling operating mode”. The observer dynamics has been selected such that the estimated load moment \hat{M}_{L} converges during the duration of a percussion cycle, such that the estimated load moment \hat{M}_{L} corresponds to a smoothed estimated load moment \hat{M}_{L}. The limit value 26c is set such that, in the case of a comparison of the estimated load moment \hat{M}_{L} with the limit value 26c, the estimated load moment \hat{M}_{L} in the percussion operating mode is greater than the limit value 26c, and in the idling operating mode is less than the limit value 26c. In the example, the limit value 26c is half the mean estimated load moment \hat{M}_{L} in the percussion operating mode. As a result of the smoothing of the estimated load moment \hat{M}_{L}, owing to the selected observer dynamics, the estimated load moment \hat{M}_{L} remains continuously above the limit value 26c during the percussion operating mode. The control unit 14c furthermore includes a protective circuit, which switches off the drive unit 30c of the percussion mechanism 16c on account of overload if a maximum value 126c of the estimated load moment \hat{M}_{L} is exceeded.

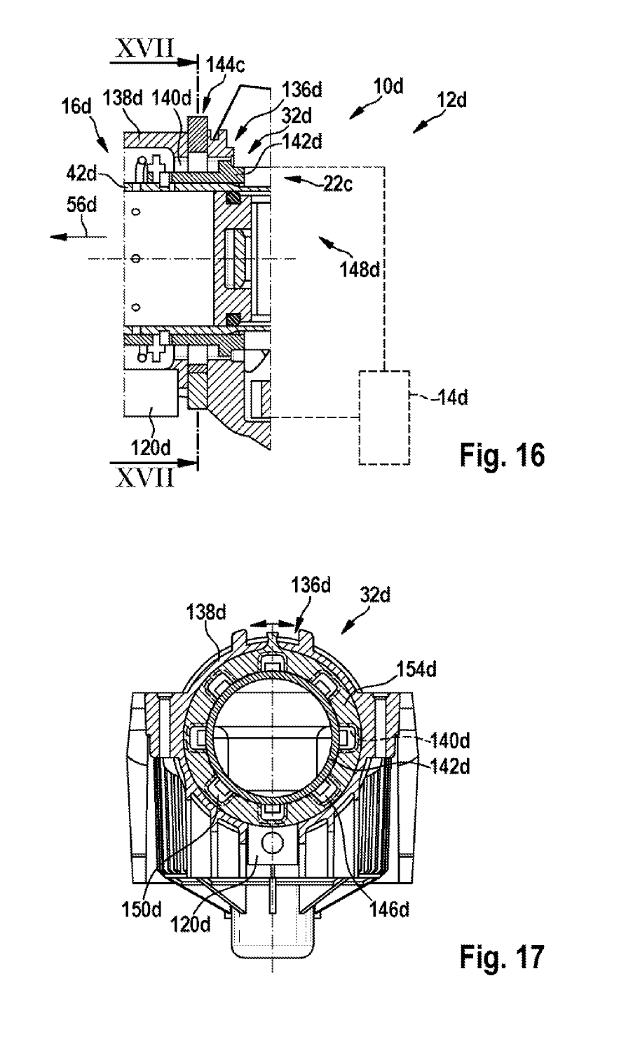

FIG. 16 and FIG. 17 show a percussion mechanism unit 10d for a rotary and percussion hammer 12d in a further exemplary embodiment. The percussion mechanism unit 10d differs from the preceding percussion mechanism unit in that an operating parameter defined by a control unit 14d is a throttle characteristic quantity of a venting unit 32d. A percussion space in a hammer tube 42d is delimited by a striking pin and a striker. The venting unit 32d has venting openings in the hammer tube 42d for venting the percussion space. The venting unit 32d serves to balance the pressure of the percussion space with an environment of a percussion mechanism 16d. The venting unit 32d has a setting unit 136d. The setting unit 136d is provided to influence venting of the percussion space, disposed in front of the striker in a percussion direction 56d, during a percussion operation. The hammer tube 42d of the percussion mechanism 16d is mounted in a transmission housing 138d of the rotary and percussion hammer 12d. The transmission housing 138d has ribs 140d, which are disposed in a star configuration and face toward an outside of the hammer tube 42d. Pressed in between the hammer tube 42d and the transmission housing 138d, in an end region 144d that faces toward an eccentric gear mechanism, there is a bearing bush 142d, which supports the hammer tube 42d on the transmission housing 138d. The bearing bush 142d, together with the ribs 140d of the transmission housing 138d, forms air channels 146d, which are connected to the venting openings in the hammer tube 42d. The air channels 146d constitute a part of the venting unit 32d. The percussion space is connected, via the air channels 146d, to a transmission space 148d disposed behind the hammer tube 42d, against the percussion direction 56d. The air channels 146d constitute throttle points 150d, which influence a flow cross section of the connection of the percussion space to the transmission space 148d. The setting unit 136d is provided to set the flow cross section of the throttle points 150d. The air channels 146d constituting throttle points 150d constitute a transition between the percussion space and the transmission space 148d. A setting ring 194d has inwardly directed valve extensions 154d disposed in a star configuration. Depending on a rotary position of the setting ring 194d, the valve extensions 154d can fully or partially overlap the air channels 46d. The flow cross section can be set by adjustment of the setting ring 194d. The control unit 14d adjusts the setting ring 194d of the setting unit 136d by rotating the setting ring 194d by means of a servo drive 120d. If the venting unit 32d is partially closed, the pressure in the percussion space that is produced upon a movement of the striker in the percussion direction 56d can escape only slowly. A counter-pressure forms, directed against the movement of the striker in the percussion direction 56d. This counter-pressure assists a return movement of the striker, against the percussion direction 56d, and thereby assists a percussion mechanism start. If the value selected for the percussion-mechanism rotational speed is an above-critical working value at which a reliable percussion mechanism start is not possible with the venting unit 32d open, the control unit 14d partially closes the venting unit 32d, for the purpose of changing from the idling operating mode to the percussion operating mode. Starting of the percussion operating mode is assisted by the counter-pressure in the percussion space. After the percussion mechanism has been started, the control unit 14d opens the venting unit 32d again. The control unit 14d can also use the operating parameter of the throttle characteristic quantity of the venting unit 32d for the purpose of regulating output.

1. A percussion mechanism unit for at least one of a rotary hammer and a percussion hammer, comprising:
a pneumatic percussion mechanism; and
a control unit configured to control the pneumatic percussion mechanism by at least one of open-loop control and closed-loop control, the control unit has having at least one load estimator.

2. The percussion mechanism unit as claimed in claim 1, wherein the load estimator is a load observer.

3. The percussion mechanism unit as claimed in claim 1, wherein the control unit is provided is configured to identify an operating state of the pneumatic percussion mechanism.

4. The percussion mechanism unit as claimed in claim 1, wherein the control unit is configured to process at least one operating parameter.

5. The percussion mechanism unit as claimed in claim 4, wherein the control unit is configured to process the at least one operating parameter as a function of at least one known load and at least one unknown load to be estimated.

6. The percussion mechanism unit as claimed in claim 5, wherein the control unit comprises has a filter unit configured to estimate the at least one unknown load from the at least one operating parameter by filtering with a known frequency band.

7. The percussion mechanism unit as claimed in claim 5, wherein the control unit is configured to determine an operating state of the pneumatic percussion mechanism by comparing the estimated at least one unknown load with at least one limit value.

8. The percussion mechanism unit as claimed in claim 1, wherein the control unit is configured to determine at least one known load in a learning mode.

9. The percussion mechanism unit as claimed in claim 2, wherein the control unit is configured to estimate a driving torque of a drive unit using a dynamic model.

10. The percussion mechanism unit as claimed in claim 9, wherein the control unit is configured to determine model parameters of the dynamic model from a comparison of measured and estimated parameters.

11. The percussion mechanism unit as claimed in claim 9, wherein the control unit is configured to determine an operating state by comparing at least one parameter with at least one limit value.

12. The percussion mechanism unit as claimed in claim 1, wherein the control unit is configured, in at least one operating state, to set at least one operating parameter temporarily to a start value to change from an idling operating mode to a percussion operating mode.

13. The percussion mechanism unit as claimed in claim 12, wherein one of the at least one operating parameter is a throttle characteristic quantity of a venting unit.

14. The percussion mechanism unit as claimed in claim 12, wherein one of the at least one operating parameter is a percussion frequency.

15. The percussion mechanism unit as claimed in claim 1, further comprising:
a mode change sensor configured to signal a change of an operating mode.

16. A hand power tool, comprising:
a percussion mechanism unit, the percussion mechanism unit comprising:
a pneumatic percussion mechanism; and
a control unit configured to control the pneumatic percussion mechanism by at least one of open-loop control and closed-loop control, the control unit having at least one load estimator.

17. A control unit of a percussion mechanism unit, the percussion mechanism unit comprising:
a pneumatic percussion mechanism; and
a control unit configured to control the pneumatic percussion mechanism by at least one of open-loop control and closed-loop control, the control unit having at least one load estimator.

18. A method for estimating a load for a percussion mechanism unit as claimed in claim 1, comprising:
estimating the load using the at least one load estimator.
